(19) United States
(12) Patent Application Publication
(10) Pub. No.: US 2003/0077389 A1
(43) Pub. Date: Apr. 24, 2003

(54) Method and apparatus for surfacing inner wall of swimming pool

(76) Inventor: John C. Jones, Mesa, AZ (US)

Correspondence Address: Tod R. Nissle, Esq., TOD R. NISSLE, P.C., P.O. Box 55630, Phoenix, AZ, 85078, US

(21) Appl. No.: 10/032,902

(22) Filed: Oct. 19, 2001

(51) Int. Cl. B05D 3/12; B05D 3/02; C04B 14/04

(52) U.S. Cl. 427/355; 427/376.1; 106/737

(57) ABSTRACT

A surfacing method and apparatus produce a smooth surface on the wall of a swimming pool. The smooth surface minimizes both algae growth on the pool wall and skin abrasions caused by the surface. The method and apparatus utilize a cement slurry composition which includes a liquid bonding agent and fibers to increase the strength of the surface so the surface can be polished by a water cooled diamond impregnated surfacing wheel.

This invention pertains to swimming pools.

More particularly, this invention pertains to a method and apparatus for surfacing the water-contacting wall of a swimming pool.

In a further respect, the invention pertains to a pool wall surfacing method and apparatus which provides a “pebble” appearance while reducing the risk of injury to a swimmer's skin and reducing the ability of algae to grow in and on the pool wall surface.

Various pool surfaces are known. One surface is the conventional plaster surface. Another surface is the pebble surface. The pebble surface consists of small aggregate (or pebbles) mixed with plaster. The appearance of the pebble surface is pleasing, which has resulted in the surface being applied to many swimming pools. One disadvantage of the pebble surface is that portions of the pebbles extend above the plaster and can cut or injure a swimmer's skin, especially the skin on the sole of a swimmer's foot. Another disadvantage of the pebble surface is that it uses plaster. Plaster is relatively porous and provides niches in which algae can grow.

Accordingly, it would be highly desirable to provide an improved method and apparatus for applying a pebble surface to the wall of a swimming pool while reducing the risk that the surface will injure the skin of a swimmer and that algae can grow in the pebble surface.

Therefore, it is a principal object of the instant invention to provide an improved method and apparatus for surfacing the wall of a swimming pool.

A further object of the invention is to provide an improved method and apparatus for producing a pebble surface which will minimize the risk of injury to a swimmer, which will be pleasing to the eye, and which will make it more difficult for algae to grow in a swimming pool.

These and other, further and more specific objects and advantages of the invention will be apparent from the following detailed description of the invention, taken in conjunction with the drawings, in which:

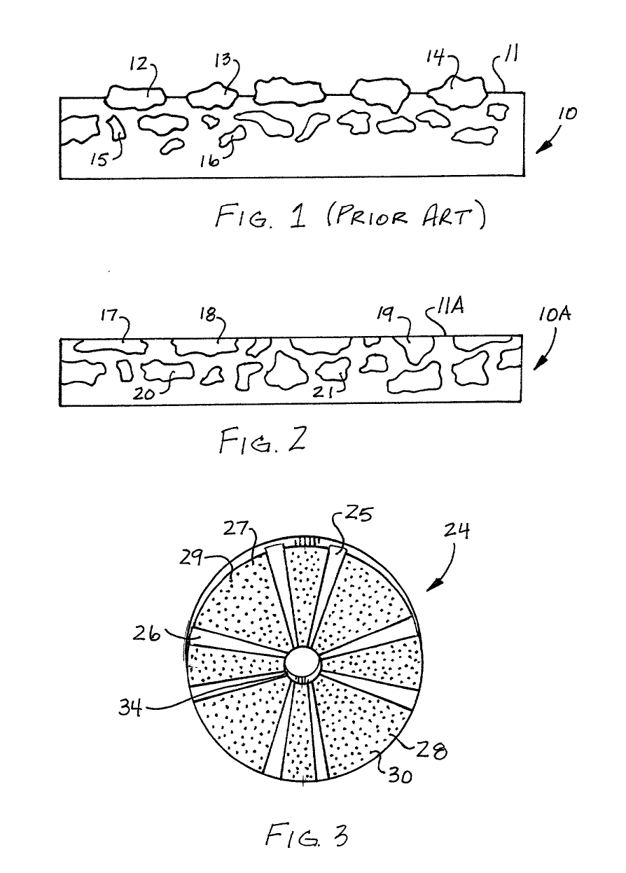

FIG. 1 is a side section view illustrating a conventional pebble coating on the surface of the wall of a swimming pool;

FIG. 2 is a side section view illustrating a pebble coating produced in accordance with the principles of the invention;

FIG. 3 is a front view illustrating a diamond polishing pad utilized in the practice of the invention; and,

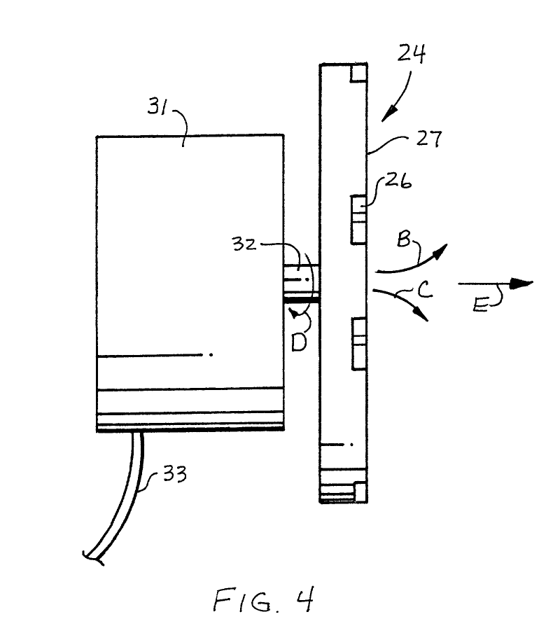

FIG. 4 is a side elevation view illustrating the pad of FIG. 3 mounted on a polishing apparatus which rotates the pad and provides water for cooling the surface of the pad.

Briefly, in accordance with my invention, I provide a cement plaster composition comprising from about 20% to about 50% by weight of a Portland cement; from about 50% to about 80% by weight of aggregate; from about 1% to about 5% by weight of a silica filler; from about 0.25% to 5% by weight of a liquid bonding agent; and, the balance water.

In another embodiment of the invention, I provide an improved method for coating a surface of a swimming pool comprising the step of applying to the surface a cement plaster composition. The composition includes from about 20% to about 50% by weight of a Portland cement; from about 50% to about 80% by weight of aggregate; from about 1% to about 5% by weight of a silica filler; from about 0.25% to 5% by weight of a liquid bonding agent; from about 0.025% to 1% by weight of plastic fibers; and, the balance water.

In a further embodiment of the invention, I provide an improved method for coating a surface of a swimming pool. The method includes the step of applying to the surface a cement plaster slurry composition. The composition includes from about 20% to about 50% by weight of a Portland cement; from about 50% to about 80% by weight of aggregate; and, the balance water. The method also includes the steps of allowing the slurry composition to dry; and, polishing the dry slurry composition with a rotating water cooled polishing head embedded with hard particles such that a smooth surface is formed in which aggregate particles are polished.

Turning now to the drawings, which depict the presently preferred embodiments of the invention for the purpose of illustrating the practice thereof and not by way of limitation of the scope of the invention, and in which like reference characters refer to corresponding elements throughout the several views, FIG. 1 illustrates a conventional pebble coating for a swimming pool. In a conventional coating, pebbles 12, 13, 14 are embedded in and extend above the surface 11 of cement 10. Other pebbles 15, 16 are embedded in cement 10 below surface 11. FIG. 2 illustrates a pebble coating produced in accordance with the method of the invention and includes pebbles 17 to 19 polished flush with surface 11A of cement 10A. The polished pebbles and cement 10A collectively produce a smooth surface which is highly unlikely to injure a swimmer's feet or skin and which make it significantly more difficult for algae to grow on the surface. In FIG. 2, other pebbles 20, 21 are embedded in cement 10A beneath surface 11A. If desired, pebbles 17 to 19 need not be polished flush with surface 11A, but can be polished smooth souch that a portion of one or more pebbles 17 to 19 extends a distance outwardly from surface 11A so that the resulting combination of the polished pebbles 17 to 19 and polished surface 11A is not flat but is still smooth to the touch and generally does not include sharp pebble edges that extend outwardly from surface 11A.

The cylindrical polishing head 24 illustrated in FIG. 3 includes a plurality of radial grooves 25, 26 each extending between a pair of adjacent pie-shaped portions having a flat planar surface 28, 29 embedded with hard particles. As used herein, hard particles comprise particles having a hardness at least as high as 8, preferably a hardness of 10, where the hardness scale is:

| Hardness | Material |
|---|---|
| 1 | Talc |
| 2 | Gypsum |
| 3 | Calcite |
| 4 | Fluorite |
| 5 | Apatite |
| 6 | Feldspar |
| 7 | Quartz |
| 8 | Topaz |
| 9 | Corundum |
| 10 | Diamond |

The cylindrical polishing head 24 can be of any desired shape and dimension, but will always include a surface 28, 29 embedded with hard particles 30, will always be liquid (i.e., usually water) cooled, and usually will always have inset grooves or channels which permit water and abraded particles to flow outwardly from the center of head 24. Surfaces 28, 29 typically are fabricated from rubber or metal. While surfaces 28, 29 can be somewhat concave or convex, they usually are relatively flat and planar.

In FIG. 4, polishing head 24 is mounted on a shaft 32 which is rotated in the direction of arrow D by electric motor 31 or other motive power source. Shaft 32 is mounted in motor 31. Electrical cord 33 delivers electricity to motor 31. Motor 31 typically includes a handle or some other means for an individual to hold motor 31 and to press head 24 and motor 31 in the direction of arrow E against a pool coating to polish the surface of the coating with the diamonds or other hard particles embedded in surface 28, 29. Water is provided by a pressurized hose (not shown) and exits through the center of head 24 in the direction of arrows B and C, typically under a pressure of 10 to 100 psi. The points at which water exits head 24 or is applied intermediate head 24 and the surface being polished can vary as desired. Polishing head 24 is of a type which has long been utilized to polish marble, but apparently has never been utilized to polish the wall of a swimming pool. One likely reason that head 24 was not previously used to polish a swimming pool wall is that conventional cement plaster used on swimming pool walls would crumble and be destroyed or severely damaged by head 24. In the practice of the invention, a special cement plaster mixture is used which can withstand polishing with a diamond studded polishing head generally without permitting the pebbles to be ripped out of the plaster by the polishing head. It is also critical that the polishing head 24 be water cooled and lubricated to carry heat away from the pool coating being polished and to facilitate the movement of the diamonds over the pool coating. Polishing head 24 is cooled by, while head 24 is rotating and polishing a coating surface, directing water or another liquid coolant under pressure between the polishing head 24 and the surface being polished.

The coating slurry composition of the invention is used to form a relatively thin coating on the surface of a swimming pool wall. The coating composition includes from about 20% to 50%, preferably 30% to 40%, by weight of a Portland cement, from about 50% to 80%, preferably 60% to 70%, by weight of aggregate, and water. The composition can also include from about 1% to 5% by weight of a silica filler; from about 0.25% to 5% by weight of a liquid acrylic bonding agent; and/or from about 0.025% to 5% by weight of plastic fibers. Dyes, in liquid or dry form, can also be incorporated.

The Portland cement is usually white, but can be grey or otherwise colored.

The aggregate can be any aggregate or combination of aggregates used in cement plaster compositions for coating the wall of a swimming pool. While the size of the aggregate can vary as desired, each particle of the aggregate usually has a maximum width of ½″, preferably ¼, or less. Examples of aggregate include calcium carbonate, silica sand, quartz, and pebble stones.

The silica filler reacts with calcium hydroxide (lime) in the cement mixture to create calcium silicate. This produces a stronger coating composition and reduces the likelihood that the composition will crack when it dries. The silica filler can comprise pozzolan, barium sulphate clay, ground silica, kaoline clay, bauxite, diatomaceous earth, bentonite, sepiolite, and mixtures thereof. The silica filler normally is finely ground and includes 100 to 300 mesh particles. A pozzolan is a pulverent siliceous or siliceous aluminous substance that reacts chemically with slaked lime at ordinary temperature and in the presence of moisture to produce a cementitious compound. A variety of pozzolans are known and are commercially available.

The plastic fibers utilized are less than about 1″ in length, preferably less than about ¼″ in length, and have a diameter or width less than 0.10 inch, preferably less than 0.005 inch. These fibers, in combination with the silica filler and the liquid acrylic bonding agent, assist in producing a strong coating composition which can, when dry, permit a diamond impregnated polishing head to polish the coating composition to produce a smooth, even coating surface. The fibers preferably are not be susceptible to being dissolved or broken down by other components in the coating composition of the invention. The fibers presently utilized comprise ⅛″ long pliable polypropylene fibers. Fibers made from any other desired plastic, rubber, or other material can also be utilized.

The liquid bonding agent is critical in the practice of the invention and functions to improve the structural strength of the dried coating composition and to facilitate the ability of the coating composition to be polished with a pad embedded with diamond particles or with another hard substance that polishes the dried coating composition. The liquid bonding agent can be obtained from a variety of suppliers. One brand of acrylic bonding agent is ACRYL BONDER(™) sold by CCI, Columbus Chemical Industries, Inc. of 4430 North 39^{th} Avenue, Phoenix, Ariz. 85019. The liquid bonding agent used in the practice of the invention is an emulsion in water of a synthetic rubber or plastic. The synthetic rubber or plastic is obtained by polymerization. For example, ACRYL BONDER is used as a liquid bonding agent in the practice of the invention. ACRYL BONDER includes about 66% by weight water and 34% by weight of Dow Chemical Company resin DL 460NA. The Dow Chemical Company DL 460A resin includes from 40% to 60% by weight of a styrene/butadiene polymer and from 40% to 59% by weight water. The DL 460A resin is a milky white emulsion. This milky white color likely results when styrene and butadiene are mixed with a catalyst. The catalyst causes the styrene and butadiene to combine and polymerize. Along with styrene and butadiene, synthetic rubber/plastic emulsions can be produced using isobutylene (gas), isoprene (liquid), acetylene gas, acrylonitrile, ethylene dichloride, sodium polysulfide, ethylene, propylene, glycols, adipic acid, diisocyanates, oxygen, silicon, fluorinated organic compounds, and/or other compounds, along with catalysts when appropriate. However, water emulsions of polymerized styrene/butadiene are presently preferred in the practice of the invention. Powdered (or solid) mixtures of polymerized rubbers or plastic can also be utilized. Liquid emulsions are, however, presently preferred. The emulsions can include thickeners (including acrylic resins) and stabilizers. Processes for producing synthetic rubber/plastic emulsions are well known in the art and are not detailed herein.

Dyes and other coloring agents can be added to the coating composition of the invention and typically comprise from 0.5 to 4% by weight of the composition. Unless otherwise indicated, the weight percentages given herein refer to the weight percent of a component in the coating composition when the composition is a slurry and has not yet dried.

The following examples are given by way of illustration, and not limitation, of the invention.

### EXAMPLE 1

The following materials are provided:

| | |
|---|---|
| Material | Amount |

| | | |
|---|---|---|
| Liquid acrylic bonding agent | 1 | gallon |
| Bayer Red #110 Dry Dye | 4 | lb. |
| White Portland cement (4 bags) | 376 | lb. |
| Pozzolan | 50 | lb. |
| Pebbles (each 1/16″ to ¼″ width), gold color | 500 | lb. |
| Pebbles (1/16″ to ¼″ width), black color | 100 | lb. |

The foregoing materials are admixed with about twenty-five gallons of water to form a slurry. As is appreciated by those of skill in the art, the amount of water added varies somewhat depending on the humidity, whether the sun is out, whether the pool wall to which the slurry is applied is dry, is damp, etc. The slurry is sprayed onto the wall of an empty swimming pool, is troweled on, or is otherwise applied to the swimming pool wall. The slurry is worked with a trowel or other tool to produce a relatively smooth swimming pool coating surface which follows the desired contours of the sides and bottom of the pool wall. Even though the coating surface is relatively smooth, pebbles extend outwardly from the cement surface in the manner illustrated in FIG. 1. The coating is allowed to dry, typically for at least a day. While the coating dries, it can be periodically misted with water to slow the curing process and reduce the likelihood that the coating will crack. The thickness of the coating can vary, but is typically less than an inch and one-half, preferably less than about three-fourths of an inch thick but at least one-fourth of an inch thick.

After the coating dries, the polishing apparatus of FIG. 4 is utilized to polish the surface of the coating to produce the smooth, uniform surface including surface 11A and including pebbles 17 to 19 polished flush with surface 11A, as shown in FIG. 2. Polishing a one foot square area of the dried coating to produce the surface illustrated in FIG. 2 typically takes about two minutes, but this time can varying depending on several variable including the hardness of the pebbles being polished, the quantity of diamond pieces in the polishing apparatus, the RPM of the polishing apparatus wheel, etc. During this polishing process, the apparatus of FIG. 4 is manually pressed against and reciprocated and moved over the coating surface.

After the coating is polished, it is acid washed and the pool is filled with water.

### EXAMPLE 2

| Material | Amount | |
|---|---|---|
| Polypropylene fiber, ⅛″ long x 0.003″ diameter | 1 | lb. |
| White Portland cement (5 bags) | 470 | lb. |
| Pozzolan | 25 | lb. |
| Pebbles (each 1/16″ to ¼″ wide), gold color | 500 | lb. |
| Pebbles (1/16″ to ¼″ wide), black color | 100 | lb. |

The foregoing materials are admixed with about twenty-five gallons of water to form a slurry. The slurry is sprayed onto the wall of a swimming pool, is troweled on, or is otherwise applied to the wall of an empty swimming pool. The slurry is worked with a trowel or other tool to produce a relatively smooth swimming pool coating surface which follows the desired contours of the sides and bottom of the pool wall. Even though the coating surface is relatively smooth, pebbles extend outwardly from the cement surface in the manner illustrated in FIG. 1. The coating is allowed to dry, typically for at least a day. While the coating dries, it can be periodically misted with water to slow the curing process and reduce the likelihood that the coating will crack. The thickness of the coating can vary, but is typically less than an inch and one-half, preferably less than about three-fourths of an inch thick but at least one-fourth of an inch thick.

After the coating dries, it is acid washed and the pool is filled with water.

A greater amount of cement (5 bags) is utilized in this Example 2 than in Example 1 (4 bags). The amount of cement is reduced in Example 1 and pozzolans (silica filler) are added to increase the adhesion between the pebbles and the concrete and, consequently, to increase the strength of the coating. Fibers can be added to the composition of FIG. 1 to further increase the strength of the dried composition and to reduce the likelihood that the dried composition will crack.

When the cement plaster aggregate composition applied to the surface of a pool wall will be polished with the apparatus of FIG. 4, the ratio of the silica filler to the cement is currently about 1:7.5, is in the range of 1:3 to 1:11, and is preferably in the range of 1:5 to 1:10; and, the ratio of cement to aggregate is in the range of 1:1 to 1:2, preferably 1:1.4 to 1:1.6. These relationships are important in the practice of the invention and in producing a dried coating which can be successfully polished without being unduly pitted or damaged by the polishing head 24.

When the cement plaster aggregate composition applied to the surface of a pool wall is not intended to be polished with the apparatus of FIG. 4, the ratio of silica filler to the cement is about 1:19, is in the range of 1:14 to 1:24, and is preferably in the range of 1:16 to 1:22; and, the ratio of cement to aggregate is currently about 1:1.27, is in the range of 1:1 to 1:1.42, preferably 1:1.5 to 1:1.35.

Having described my invention in such terms as to enable those of skill in the art to make and practice it, and having described the presently preferred embodiments thereof, I Claim:

1. A cement plaster composition comprising
(a) from about 20% to about 50% by weight of a Portland cement;
(b) from about 50% to about 80% by weight of aggregate;
(c) from about 1% to about 5% by weight of a silica filler;
(d) from about 0.25% to 5% by weight of a liquid bonding agent; and,
(e) the balance water.

2. A method for coating a surface of a swimming pool comprising the step of applying to the surface a cement fiber composition comprising
(a) from about 20% to about 50% by weight of a Portland cement;
(b) from about 50% to about 80% by weight of aggregate;
(c) from about 1% to about 5% by weight of a silica filler;
(d) from about 0.25% to 5% by weight of a liquid bonding agent;
(e) from about 0.025% to 5% by weight of plastic fibers; and,
(f) the balance water.

3. A method for coating a surface of a swimming pool comprising the steps of
(a) applying to the surface a cement plaster slurry composition comprising
(I) from about 20% to about 50% by weight of a Portland cement;
(ii) from about 50% to about 80% by weight of aggregate; and,
(iii) the balance water; and,
(b) allowing the slurry composition to dry; and,
(c) polishing the dry slurry composition with a rotating water cooled polishing head embedded with hard particles such that a smooth surface is formed in which aggregate particles are polished.
